(19) United States
(12) Patent Application Publication
(10) Pub. No.: US 2015/0127523 A1
(43) Pub. Date: May 7, 2015

(54) METHODS AND SYSTEMS FOR PAYEE INVOICE FINANCING AND PAYMENT

(71) Applicant: Cass Information Systems, Inc., Bridgeton, MO (US)

(72) Inventors: Thomas Gerard Schaper, Wildwood, MO (US); David Garret Richardson, Weldon Spring, MO (US); Cory Jay Bricker, Chesterfield, MO (US); Mark Anthony Campbell, Glen Carbon, IL (US)

(73) Assignee: Cass Information Systems, Inc., Bridgeton, MO (US)

(21) Appl. No.: 14/073,969

(22) Filed: Nov. 7, 2013

(51) Int. Cl. G06Q 40/02; G06Q 30/04

(52) U.S. Cl. CPC G06Q 40/025; G06Q 30/04
USPC 705/38

(57) ABSTRACT

A computer system for providing financing of payee invoices is provided. The system includes a processor and a computer-readable storage device having encoded thereon computer-readable instructions that are executable by the processor. The processor receives at least one invoice from at least one payee that represents a verified debt obligation payable by a payor to the at least one payee on a specified due date. The processor also determines if the at least one verified invoice is eligible for financing to enable early payment of the at least one invoice. The processor also aggregates a plurality of financing-eligible invoices according to at least one aggregation criterion, to enable financing of the aggregated invoices as a unit, and determines whether financing of the unit of aggregated invoices, including the at least one verified invoice, will include participation by at least one partner.

### BACKGROUND OF THE DISCLOSURE

The present disclosure relates generally to methods and systems for payment of invoices by a third party contracted by a payor for goods and/or services provided by the payee. More specifically, the present disclosure relates to methods and systems for providing financing of such invoices.

A business (also referred to as a “payor”) that provides goods and/or services may incur expenses from a wide variety of sources. Some of these expenses may include purchasing goods and/or services from other businesses (referred to as “payees”). Invoices are issued by those payees to document the services or products provided and to request payment. The payor for various reasons may contract with a third-party business (referred to as an “invoice payment service provider” or “IPSP”) to attend to the processing, review, and payment of the invoices.

Typically, a payor and a payee agree to terms regarding the amount and timing of payment for goods and/or services delivered prior to or at the time of ordering of the goods and/or services. Such terms may appear in a purchase order issued by the payor, and/or in an invoice issued by the payee at the time of shipment of the goods or provision of the services by the payee. One of the terms addressed is the timing of payment for the goods and/or services. The payment terms may include, but are not limited to, a statement that payment must be received by a specified date or within a predetermined period of time following receipt of the invoice by the payor.

It is frequently desirable for a payor to retain possession of cash (or its equivalent) designated for payment of debts owed by the payor for as long as possible in order to maintain a desired level of cash flow. However, customary payment terms provided in an invoice from a payee may require payment sooner than a payor would prefer. Conversely, payees desire to receive payment as soon as possible following the delivery of goods and/or services in order to increase the amount of funds the payee has “on hand” at any given time. In at least some known commercial transactions, payees that contract directly with their payors offer credit to their payors in the form of a discount, wherein the payee agrees to accept payment in an amount (often a predetermined fixed percentage) that is less than a face value of an invoice, provided that the payee receives payment for the invoice by a predetermined date that is earlier than a payment due date specified in the invoice. However, the payees may only offer such credit to payors that are high-volume payors, or for invoices that are greater than a predetermined, and frequently high, dollar amount.

In at least some known invoice payment arrangements in which an IPSP is involved, financing of invoices may be provided by the IPSP, in the form of a fixed or variable discount, wherein the payee receives early payment for an invoice in an amount less than the face value of the invoice. In addition, in at least some known invoice payment arrangements involving an IPSP, invoice financing may be provided via a third-party partner financial institution, such as a bank. However, in order to obtain third-party financing for a payee's invoices, the average dollar size of the payee's invoices and/or the cumulative amount of the invoices usually must be of a sufficiently large size to attract the interest of most potential third-party financial institutions.

### BRIEF DESCRIPTION OF THE DISCLOSURE

In one embodiment, a computer-implemented method for providing financing of payee invoices is provided. The method is implemented using a computer device coupled to a memory device. The method includes receiving at least one invoice from at least one payee, wherein the at least one invoice represents a verified debt obligation payable by a payor to the at least one payee on a specified due date. The method also includes determining if the at least one verified invoice is eligible for financing to enable payment of the at least one invoice by an agreed date that is prior to the specified due date. The method also includes determining whether financing of the at least one verified invoice will include participation by at least one partner. The method also includes aggregating a plurality of financing-eligible invoices, including the at least one verified invoice, according to at least one aggregation criterion, to enable financing of the aggregated invoices as a unit. The method also includes receiving financing approval information from the at least one partner, if the financing of the unit of aggregated invoices includes participation by at least one partner.

In another embodiment, a computer system for providing financing of payee invoices is provided. The system includes a processor and a computer-readable storage device having encoded thereon computer-readable instructions that are executable by the processor. The computer-readable instructions cause the processor to receive at least one invoice from at least one payee, wherein the at least one invoice represents a verified debt obligation payable by a payor to the at least one payee on a specified due date. The computer-readable instructions also cause the processor to determine if the at least one verified invoice is eligible for financing to enable payment of the at least one invoice by an agreed date that is prior to the specified due date. The computer-readable instructions also cause the processor to determine whether financing of the at least one verified invoice will include participation by at least one partner. The computer-readable instructions also cause the processor to aggregate a plurality of financing-eligible invoices, including the at least one verified invoice, according to at least one aggregation criterion, to enable financing of the aggregated invoices as a unit. The computer-readable instructions also cause the processor to receive financing approval information from the at least one partner, if the financing of the unit of aggregated invoices includes participation by at least one partner.

In another embodiment, computer-readable storage media having computer-executable instructions thereon are provided. When executed by at least one processor associated with a host computer device and a memory device, the computer-executable instructions cause the processor to receive at least one invoice from at least one payee, wherein the at least one invoice represents a verified debt obligation payable by a payor to the at least one payee on a specified due date. The computer-readable instructions also cause the processor to determine if the at least one verified invoice is eligible for financing to enable payment of the at least one invoice by an agreed date that is prior to the specified due date. The computer-readable instructions also cause the processor to determine whether financing of the at least one verified invoice will include participation by at least one partner. The computer-readable instructions also cause the processor to aggregate a plurality of financing-eligible invoices, including the at least one verified invoice, according to at least one aggregation criterion, to enable financing of the aggregated invoices as a unit. The computer-readable instructions also cause the processor to receive financing approval information from the at least one partner, if the financing of the unit of aggregated invoices includes participation by at least one partner.

### BRIEF DESCRIPTION OF THE DRAWINGS

FIG. 1 is a schematic illustration of an example payee invoice payment system environment.

FIG. 2 is a simplified block diagram of an example invoice payment system infrastructure in accordance with one embodiment of the present disclosure.

FIG. 3 is an expanded block diagram of example server architecture of the invoice payment system shown in FIG. 1.

FIG. 4 illustrates an example configuration of a user computer device shown in FIGS. 2 and 3.

FIG. 5 illustrates an example configuration of a server computer device as shown in FIGS. 2 and 3.

FIG. 6 illustrates a process for setting up the payee invoice payment system environment illustrated in FIG. 1.

FIG. 7 is a flowchart illustrating an example method for the receipt, processing, financing, and payment of invoices received from a payee for a payor.

### DETAILED DESCRIPTION OF THE DISCLOSURE

The methods and systems described herein facilitate processing, financing, and payment of invoices by an invoice payment service provider (“IPSP”). Specifically, the methods and systems described herein enable payees to receive payment in advance of a predetermined payment date stated in an invoice, in exchange for an agreement to accept, as payment in full, an amount that is less than an invoiced amount. In addition, the methods and systems described herein enable the financing of invoices that are of an amount that previously would not have been considered for financing. As used herein, the term “debt obligation” includes any open payment obligation owed by a payor to a payee.

In an example embodiment, an invoice payment system operated by an invoice payment service provider (“IPSP”) receives invoices directed to a payor from one or more payees from whom the payor has purchased goods and/or services. More specifically, the invoice payment system is implemented via a computer device associated with the IPSP. The invoice payment system processes the received invoices to verify the correctness of the invoices to enable approval of the invoices for payment. The system uses a plurality of applicable business rules, including but not limited to, rules provided and/or specified by the payor to determine whether the invoices represent legitimate debt obligations payable by the payor. After verification, the invoices are subjected to payment processing to determine when the payor is to be notified that funds are due, to determine when the funds are actually due to the IPSP, and when payment to the payee is to be made.

The systems described herein also determine whether the payee(s) associated with the invoices is/are eligible to receive invoice financing that would enable that payee(s) to be paid in advance of payment due date(s) provided on the invoice(s). If an invoice is eligible for financing, one of two general invoice financing formats may be applied. For example, financing can be entirely payee-driven (early payment in exchange for a straight discount) or can be payor-driven (a calculated discount based on several factors). In addition, financing can involve the participation of at least one third-party partner, such as a bank or other financial institution. Furthermore, the system can determine whether under predetermined circumstances, a debt obligation or obligations embodied in the invoices should be sold outright to a third party.

In an example embodiment, the IPSP identifies invoices due to be paid by one or more payors, or due to be received by one or more payees on a specific date, or due to be received by one or more payees on a specific date, and aggregates the invoices so that the total amount of the aggregated invoices is sufficiently large to attract the interest of one or more prospective third-party partner financial institutions. The IPSP aggregates invoices according to a variety of criteria, including, but not limited to: 1) payor defined rules; 2) payee name; 3) payor name; 4) payee/payor pairings; 5) date (receipt, invoice, shipment, processing, payment due, funding due); 6) invoice type; 7) Payor name/ID and 8) currency. If the IPSP determines that an invoice will proceed under one of the financing options described above, after financing approval, a payee with a financed invoice receives payment on an agreed date prior to the due date specified in the invoice. The payor then sends funds to the third party partner (if applicable) and/or to the IPSP. Payees with non-financed invoices receive payment in due course.

As described hereinabove, the invoice payment system is implemented via a computer device associated with the IPSP. Moreover, the methods and systems described herein may be implemented using computer programming or engineering techniques including computer software, firmware, hardware (including the computer device) or any combination or subset thereof, that are associated with the IPSP, wherein the technical effects are achieved by performing at least one of the following steps: (a) receiving at least one invoice associated with at least one payee, wherein the at least one invoice represents a verified debt obligation payable by a payor to the at least one payee on a specified due date; (b) determining if the at least one verified invoice is eligible for financing to enable payment of the at least one invoice by an agreed date that is prior to the specified due date; (c) determining whether financing of the at least one verified invoice will include participation by at least one partner; (d) aggregating a plurality of financing-eligible invoices, including the at least one verified invoice, according to at least one aggregation criterion, to enable financing of the aggregated invoices as a unit; and (e) receiving financing approval information from the at least one partner, if the financing of the unit of aggregated invoices includes participation by at least one partner.

The technical effects may also be achieved by performing one or more of the following steps: (a) transmitting by the computer device payment information to the at least one payee, wherein the payment information includes information relating to payment of the at least one verified invoice by the agreed date; (b) determining a correctness of the at least one invoice through application of at least one business rule; (c) determining an eligibility of the at least one invoice for financing through application of at least one financing rule; (d) aggregating the plurality of financing-eligible invoices according to at least one of a set of payor-defined rules, a payee identity, a set of predetermined payee-payor pairings, a set of predetermined dates, an invoice type, payor name/ID, and a currency; (e) designating as a financing program, financing for a pairing of a payee with a payor; (f) assigning a financing program identifier to the financing program; (g) designating a payee for participation in a plurality of financing programs that include a plurality of payors; (h) transferring the verified debt obligation represented by the at least one verified invoice outright to a third party financial institution; and (i) receiving as payment in exchange for the transferred verified debt obligation a predetermined discount amount.

In one embodiment, a computer program is provided, and the program is embodied on a computer readable medium and utilizes a Structured Query Language (SQL) with a client user interface front-end for administration and a web interface for standard user input and reports. In an example embodiment, the system is web enabled and is run on a business-entity intranet. In yet another embodiment, the system is fully accessed by individuals having an authorized access outside the firewall of the business-entity through the Internet. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

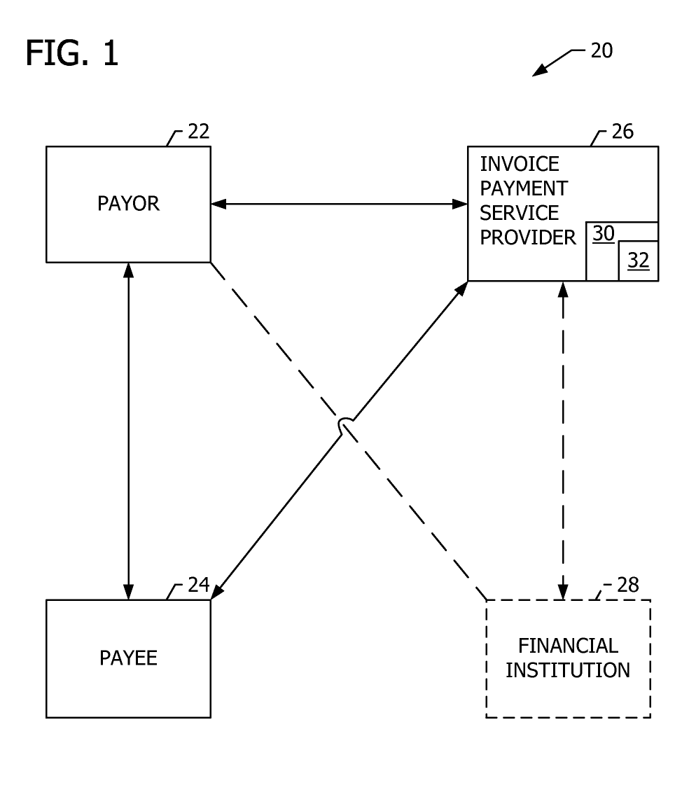

FIG. 1 is a block diagram of an example invoice payment environment 20. Environment 20 includes at least one payor 22, at least one payee 24, and an invoice payment service provider (IPSP) 26. In at least one embodiment, environment 20 also includes at least one financial institution 28. In the example embodiment, payor 22 and payee 24 are engaged in a contractual relationship for the sale of goods and/or the provision of services, such as but not limited to shipping, to payor 22.

In the example embodiment, each of payor 22, payee 24, and IPSP 26 are in two-way communication with each other, with such communication being provided by internet and/or telephonic connections, among other possible communication sources. In embodiments in which financial institution 28 is involved, financial institution 28 is also in communication with IPSP 26 and with payor 22. In the example embodiment, IPSP 26 includes an invoice payment system 30 configured to perform the processes described herein. Furthermore, in the example embodiment, IPSP 26 is a separate entity from each of payor 22, payee 24, and/or financial institution 28. Moreover, in the example embodiment, invoice payment system 30 has associated with it at least one computer device 32 through which the methods described herein may be implemented.

In the example embodiment, IPSP 26 has a contractual relationship with payor 22 for the processing and payment of invoices which payor 22 receives, from one or more payees 24, relating to the purchase of goods and/or services, such as, but not limited to, shipping services provided by payee 24 to payor 22, such that at least one invoice relates to at least one shipment made by payee 24 on behalf of payor 22. In addition, IPSP 26 has a contractual relationship with payee 24 to arrange for the financing of invoices issued by payee 24, particularly invoices that IPSP 26 is contracted to process on behalf of payor 22. Furthermore, in the example embodiment, IPSP 26 has a contractual relationship with payor 22 and/or financial institution 28 to arrange for the financing of invoices processed by IPSP 26 on behalf of payor 22. Payor 22 may have a separate direct contractual relationship with financial institution 28, relating to the re-payment of funding provided by financial institution 28 for the financing of invoices for which payor 22 is responsible.

While, as illustrated in FIG. 1, environment 20 includes a single payor 22, a single payee 24, and a single financial institution 28, in alternative embodiments, environment 20 includes any number of payors 22, payees 24, and/or financial institutions 28 that enables the invoice processing, financing and payment methods and systems described herein to function as described.

In the example embodiment, data and physical document acquisition and analysis functions are performed by IPSP 26, in addition to an actual invoice payment function. In alternative embodiments, one or more of these functions may be performed by third parties outside of IPSP 26. In addition, environment 20 may include any number of payors 22, payees 24, and/or financial institutions 28 that enables system 30 to function as described herein.

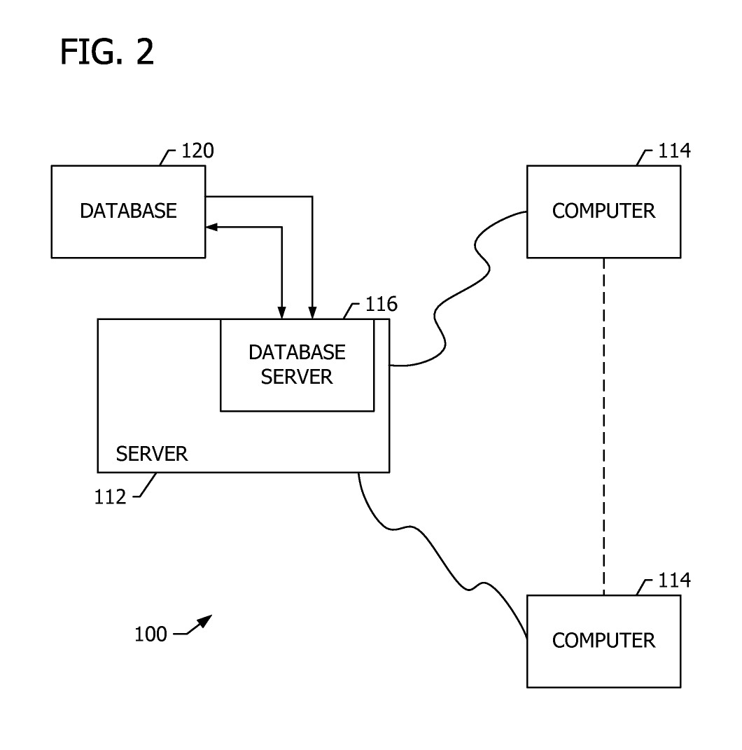

FIG. 2 is a simplified block diagram of an example infrastructure 100 used by invoice payment system 30 of IPSP 26, in accordance with one embodiment of the present disclosure. In the example embodiment, one or more components of infrastructure 100, as described herein, are included within computer device 32 (shown in FIG. 1) associated with system 30 of IPSP 26. More specifically, in the example embodiment, infrastructure 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any devices capable of interconnecting to the Internet including a web-based phone, personal digital assistant (PDA), or other web-based connectable equipment. A database server 116 is connected to database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 stores data relating to the details of payee 24's business, such as details and requirements associated with agreements and contracts payee 24 may have with payor 22. In addition, database 120 can also be used to store data pertaining to individual transactions (goods and/or services provided, shipment origin/destination points, accounting rules, pricing, payment schedules, discounts, estimated or set critical dates for pickup and delivery, etc.). Furthermore, database 120 stores data relating to the details of payor 22's business. In addition, database 120 stores accounting rules to be implemented by IPSP 26 in performing the methods described herein. The foregoing are intended to be examples of the types of data stored in database 120, and are not intended to be exhaustive or limiting.

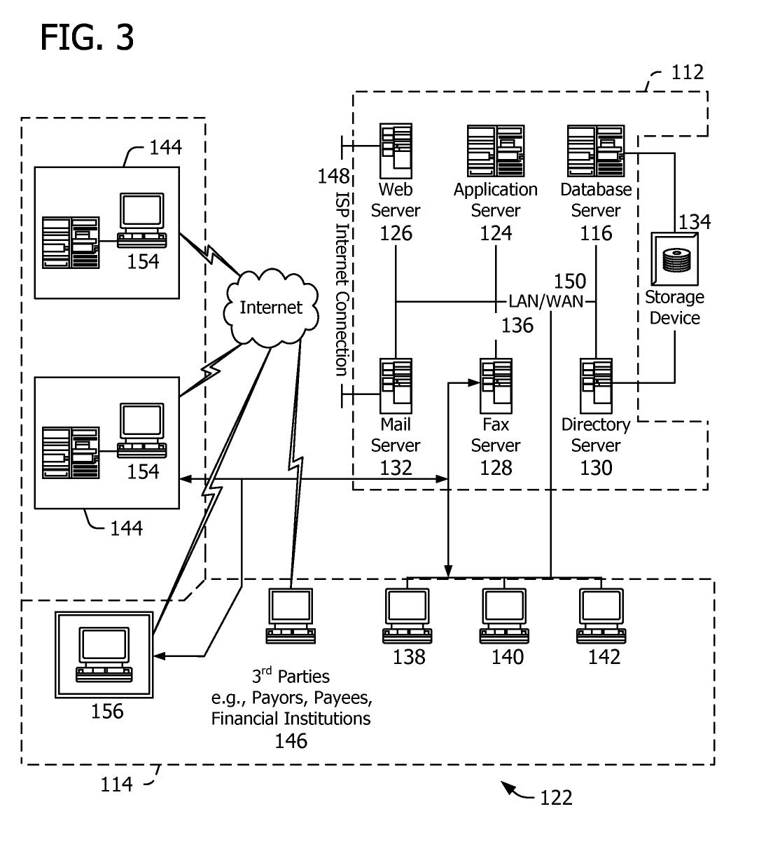

FIG. 3 is an expanded block diagram of an example embodiment of a server architecture 122 of infrastructure 100 in accordance with one embodiment of the present disclosure. Components in server architecture 122 that are identical to components of infrastructure 100 (shown in FIG. 2) are identified in FIG. 3 using the same reference numerals as are used in FIG. 2. Server architecture 122 includes server system 112 and client systems 114. Server system 112 further includes database server 116, an application server 124, a web server 126, a fax server 128, a directory server 130, and a mail server 132. A disk storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each of workstations, 138, 140, and 142 may be any computer device that includes a web browser, for example, but not limited to, a personal computer, a laptop, a tablet computer and/or a mobile phone. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., payor/payor 22, payee 24, and financial institution 28, etc. (collectively, third parties 146), using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 112. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

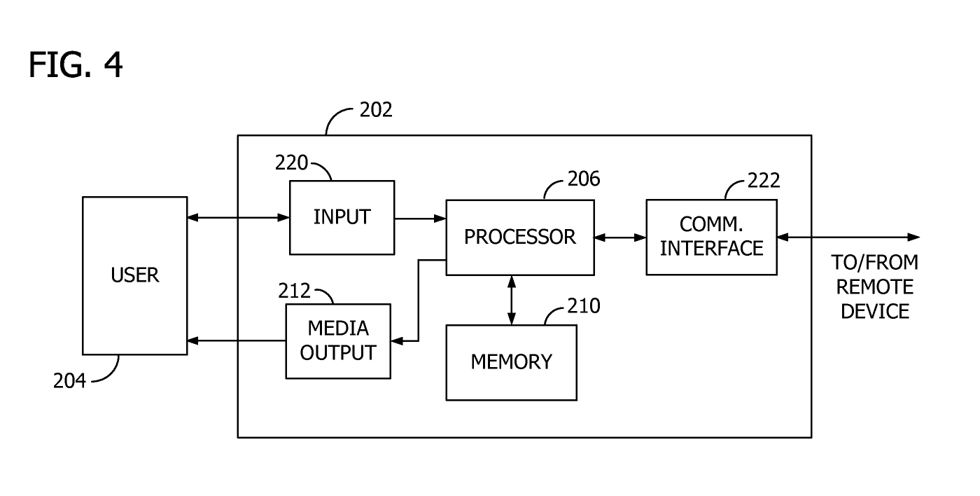

FIG. 4 illustrates an example configuration of a user computer device 202 operated by a user 204. User computer device 202 may include, but is not limited to, client systems 114, 138, 140, and 142, workstation 154, and manager workstation 156.

User computer device 202 includes a processor 206 for executing instructions. In some embodiments, executable instructions are stored in a memory area 210. Processor 206 may include one or more processing units (e.g., in a multi-core configuration). Memory area 210 is any device allowing information such as executable instructions and/or written works to be stored and retrieved. Memory area 210 may include one or more computer readable media.

User computer device 202 also includes at least one media output component 212 for presenting information to user 204. Media output component 212 is any component capable of conveying information to user 204. In some embodiments, media output component 212 includes an output adapter such as a video adapter and/or an audio adapter. An output adapter is operatively coupled to processor 206 and operatively coupleable to an output device such as a display device (e.g., a liquid crystal display (LCD), organic light emitting diode (OLED) display, or “electronic ink” display) or an audio output device (e.g., a speaker or headphones).

In some embodiments, user computer device 202 includes an input device 220 for receiving input from user 204. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 212 and input device 220.

User computer device 202 may also include a communication interface 222, which is communicatively coupleable to a remote device such as server system 112. Communication interface 222 may include, for example, a wired or wireless network adapter or a wireless data transceiver for use with a mobile phone network (e.g., Global System for Mobile communications (GSM), 3G, 4G) or other mobile data network (e.g., Worldwide Interoperability for Microwave Access (WIMAX)).

Stored in memory area 210 are, for example, computer readable instructions for providing a user interface to user 204 via media output component 212 and, optionally, receiving and processing input from input device 220. A user interface may include, among other possibilities, a web browser and client application. Web browsers enable users, such as user 204, to display and interact with media and other information typically embedded on a web page or a website from server system 112. A client application allows user 204 to interact with a server application from server system 112.

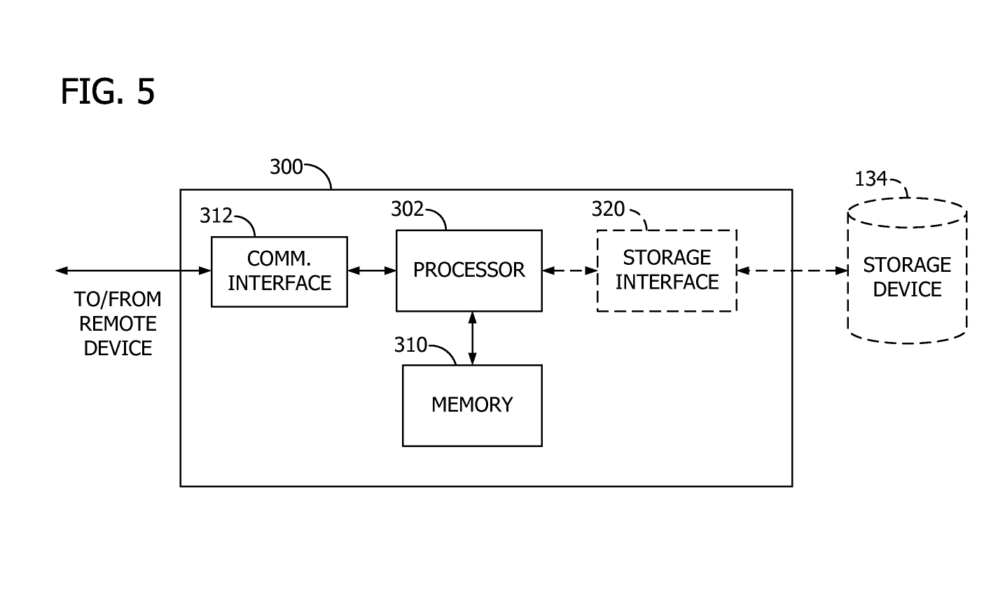

FIG. 5 illustrates an example configuration of a server computer device 300 such as may be used in server system 112 (shown in FIG. 2). Server computer device 300 may include, but is not limited to, database server 116, application server 124, web server 126, fax server 128, directory server 130, and mail server 132. Server computer device 300 also includes a processor 302 for executing instructions. Instructions may be stored in a memory area 310, for example. Processor 302 may include one or more processing units (e.g., in a multi-core configuration). Processor 302 is operatively coupled to a communication interface 312 such that server computer device 300 is capable of communicating with a remote device such as user computer device 202 or another server computer device 300. For example, communication interface 312 may receive requests from user computer device 114 via the Internet, as illustrated in FIG. 3.

Processor 302 may also be operatively coupled to storage device 134 (shown in FIG. 3). Storage device 134 is any computer-operated hardware suitable for storing and/or retrieving data. In some embodiments, storage device 134 is integrated in server computer device 300. For example, server computer device 300 may include one or more hard disk drives as storage device 134. In other embodiments, storage device 134 is external to server computer device 300 and may be accessed by a plurality of server computer devices 300. For example, storage device 134 may include multiple storage devices such as hard disks or solid state disks in a redundant array of inexpensive disks (RAID) configuration. Storage device 134 may include a storage area network (SAN) and/or a network attached storage (NAS) system.

In some embodiments, processor 302 is operatively coupled to storage device 134 via a storage interface 320. Storage interface 320 is any component capable of providing processor 302 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 134.

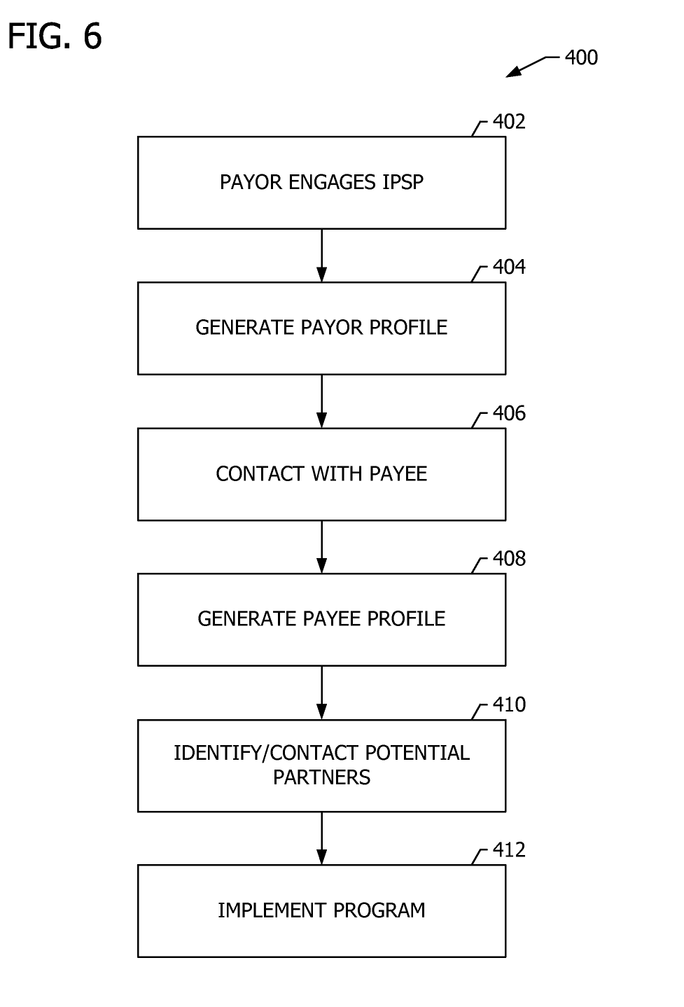

FIG. 6 illustrates a process 400 for setting up environment 20 illustrated in FIG. 1. In the example embodiment, a payor 22 engages 402 IPSP 26 to generate a program for the processing and payment by IPSP 26, via computer device 32, of invoices received by payor 22. Amongst the terms of payor 22's engagement with IPSP 26 are such terms as: 1) when payor 22 must provide funding to IPSP 26, and 2) whether payor 22 is willing to participate in one or more financing programs offered by IPSP 26. IPSP 26, via computer device 32, generates 404 a profile of payor 22 that includes various items of information, including but not limited to, 1) rules provided by payor 22 to be used by IPSP 26 to verify invoices for payment; 2) banking and/or payment account information regarding payor 22; and/or 3) detailed information regarding payees 24 with which payor 22 transacts business. Furthermore, in the example embodiment, payor 22 agrees to continue to periodically provide updated payee information to IPSP 26, for example, as payor 22 transacts business with new payees 24, or contact or other information regarding existing payees 24 changes.

After IPSP 26 generates 404 the profile for payor 22, IPSP 26 establishes contact 406 with payee 24 toward generation 408 of a payee account profile for each payee 24. For example, a payee account profile may include information such as, but not limited to, whether a payee 24 is willing to participate in an invoice financing program so that payee 24 can receive payment from IPSP for one or more invoices issued by payee 24 to payor 22.

In the example embodiment, a date by which time IPSP 26 receives funding from a payor 22 to address payments made by IPSP 26 is determined based on one of two criteria: 1) invoice processing date; and 2) invoice payment date. Under criterion 1), invoices are processed daily and can be batched on: A) a daily basis; B) a twice-weekly basis (under which 2- or 3-days' worth of invoices is aggregated); or C) a weekly basis (under which 5 business days' worth of invoices is aggregated). In the example embodiment, payor 22 and IPSP 26 agree to permit IPSP 26 to generate an ACH (Automated Clearing House) debit at the end of each processing period. In an alternative embodiment, payor 22 and IPSP 26 agree to permit payment via wire transfer or payor 22-initiated ACH debit. Under criterion 2) payor 22 and IPSP 26 agree that funding by payor 22 is to occur on a payment date scheduled for a particular invoice, or a predetermined and previously-agreed upon number of days prior to the scheduled payment date. After generation 408 of profiles for payee(s) 24, implementation 410 of the payment program begins.

IPSP 26 then identifies third party partner financial institutions 28 for potential participation in a financing program with payor 22, and enters into contractual relations with financial institutions 28. After potential partner financial institutions 28 have been identified and contractually engaged, an invoice payment program for payor 22 is implemented 412.

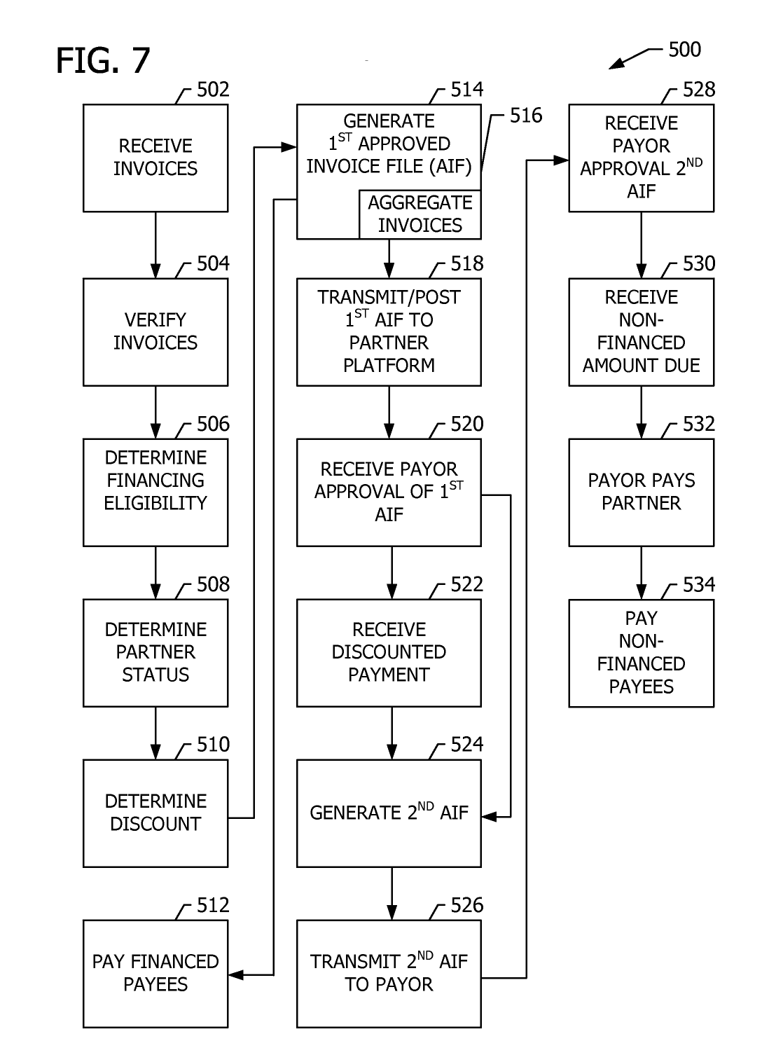

FIG. 7 is a flowchart illustrating an example method 500 for the receipt, processing, financing (if applicable), and payment of invoices received from a payee 24 for a specific payor 22. Method 500 begins when IPSP 26 receives 502 one or more invoices from one or more payees 24. In the example embodiment, IPSP 26 receives the invoices in either paper or electronic form. As described hereinabove, IPSP 26 verifies 504 the invoices using business rules contained in the payor profile generated during the set-up process 400 of an invoice payment program (FIG. 6). IPSP 26 verifies the correctness of the invoices through application of one or more business rules provided by payor 22 and included within the payor profile stored in IPSP 26, for example in database 120. Applicable business rules may include, but are not limited to, a requirement that specified data items such as date, invoice number, purchase order number, and currency, be included within an invoice and/or match with a separately maintained record of the transaction underlying the invoice. In the example embodiment, IPSP 26 processes the invoices to approval within a short period of time on the order of 3-5 business days. Once an invoice has successfully passed through the appropriate business rules, the invoice is deemed to have been “verified.”

After verification 504, IPSP 26 determines 506, on an invoice-by-invoice basis, whether an invoice is eligible for a financing program. If IPSP 26 determines that a particular invoice is not eligible for invoice financing, the invoice is segregated from financing-eligible invoices and combined with other non-financed invoices for later processing and payment as described in further detail hereinbelow. Specifically, non-financed invoices due on a future date specified in the invoices, or that are due within a predetermined period of time, are aggregated for collective payment at that future date.

In the example embodiment, IPSP 26 is configured to manage financing programs that correspond to two general types: 1) payee-driven financing; and 2) payor-driven financing. In payee-driven financing, a contractual relationship is established between individual payees 24 and IPSP 26 that governs terms including, but not limited to, the timing for payee receipt of payment for invoices, and the amount of any applicable discount. Furthermore, in payee-driven financing, payor 22 is not a party to, or even necessarily aware of, the relationships between payee(s) 24 and IPSP 26. In addition, while a payee 24 may qualify, in general, for a payee-driven financing program, for a particular invoice being examined by IPSP 26, IPSP 26 applies one or more predetermined financing rules provided by IPSP 26 to determine whether the invoice in question is eligible for financing. For example, the payor 22 to which the invoice in question is directed may not have a sufficiently robust payor base and/or may have a less than desirable credit rating. The foregoing considerations are presented as examples only. In alternative embodiments, other criteria may be considered, in addition to, or as alternatives to, the criteria described hereinabove. In payor-driven financing, payee(s) 24, payor 22, and IPSP 26 are all parties to the contractual relationship.

If IPSP 26 determines 506 that an invoice is eligible for financing, IPSP 26 determines whether the financing for the invoice will be payee-driven or payor-driven. Whether financing in a particular situation will be payee- or payor-driven depends, at least in part, on the contractual terms, if any, between payor 22, payee 24, and/or IPSP 26, which may vary from relationship to relationship. Specifically, if a particular invoice is eligible for both, then IPSP 26 may be configured to default to designating an invoice being examined for payor-driven financing. In the example embodiment, such a default may be over-ridden by IPSP 26, if other predetermined criteria are met. Such criteria may include, but are not limited to, a recent downward change in a payor 22's credit rating.

If IPSP 26 determines that financing for a particular invoice will be payor-driven, IPSP 26 also determines 508 whether the financing for the invoice will involve a third party partner, such as financial institution 28 (FIG. 1). To make this determination, IPSP 26 applies one or more rules provided by IPSP 26, including but not limited to, a size of a particular invoice or collection of invoices. For example, if a debt obligation (whether a single invoice or a collection of invoices) has a total value in excess of a predetermined value, e.g., $20 million, then IPSP 26 determines that participation by a third-party partner financial institution would be involved in the financing of the debt obligation. In addition, in one embodiment, IPSP 26 may cause IPSP 26 to apply a rule to determine whether, with respect to a particular invoice or collection of invoices an opportunity exists for IPSP 26 to engage in credit arbitrage (taking advantage of differentials in interest rates). If the opportunity does not exist, then IPSP 26 excludes third-party partner participation. In addition, payor 22 may, as part of its payor profile, provide a rule requiring that certain invoices involve third-party partner participation. Payor 22 may provide other rules to be applied by IPSP 26 that specifically authorize or exclude one or more payees 24 in predetermined circumstances also provided by payor 22.

As part of the determination 506 of financing eligibility for an invoice, IPSP 26 compares the pairing of payor 22 and payee 24 against a listing of payor-payee pairs already qualified for invoice financing. Furthermore, IPSP 26 manages different types of invoice financing programs, as described in further detail hereinbelow. IPSP 26 examines each invoice and determines if the invoice qualifies for one of the financing programs. If the payor-payee pairing is financing-eligible, IPSP 26 assigns a financing program identifier to the pairing (referencing the subject invoice), and the applicable financing rates (fixed or variable, as described hereinbelow).

In the example embodiment, IPSP 26 is configured to coordinate multiple financing programs on an ongoing basis. Specifically, IPSP 26 is configured to couple multiple payors 22 with multiple third-party partner financial institutions 28. Furthermore, IPSP 26 is configured to facilitate an individual payee 24 receiving payment discounts from multiple financing programs depending on factors such as, but not limited to, the size of the payee's payor base (payors 22), the credit quality of the payee's payors, average invoice size and cumulative invoice volume.

After IPSP 26 determines 508 whether financing for an eligible invoice involves a third-party partner, IPSP 26 determines 510 an amount of the discount to be paid by payee 24. As described above, payment to payee 24 is in an amount that equals the face value of the invoice, less a discount, which may be variable (as described in further detail hereinbelow), or a predetermined fixed value. If the invoice is eligible for financing under a payee-driven financing program that does not involve a third-party partner, and if the invoice is designated to be subject to a variable discount, the discount is determined 510 in the following manner.

First, IPSP 26 calculates a loan tenor (or period) for the invoice to be financed by determining the number of days between the invoice actual payment date (which is the date the invoice was “processed” or “verified”, plus two business days) and the payment date established by terms contained in the invoice. After IPSP 26 determines the loan tenor, IPSP 26 applies a formula to calculate the applicable discount amount. In the example embodiment, the discount formula is as follows:

Discount Amount=((LIBOR Rate+IPSP Rate)/100)*(Loan Tenor/360)*Amount of Invoice

IPSP 26 calculates the LIBOR rate as described hereinbelow. The IPSP rate is a predetermined mark-up established by IPSP 26 representing, in one embodiment, at least a portion of fees charged by IPSP 26 for services provided as described herein. IPSP 26 stores the LIBOR Rate and IPSP Rate, e.g., in database 120, as annual percentage rates. IPSP 26 calculates the LIBOR Rate by obtaining published LIBOR rates for the corresponding loan period. After IPSP 26 obtains at least two LIBOR Rate Indexes, IPSP 26 applies a standard extrapolation formula using the straight-line method in which:

LIBOR=((((TN−T1)*(R2−R1))/(T2−T1))+R1),
Where
   R1=Rate of the first known LIBOR Index Rate
   R2=Rate of the second known LIBOR Index Rate
   T1=The Term associated with R1
   T2=The Term associated with R2
   Tn=The Loan Period

If the financing-eligible invoice is designated as corresponding to a payor-driven financing program that involves a third-party partner, then IPSP 26 calculates the discount according to the following formula:

Variable Discount Amount=((LIBOR Rate+Partner Financier Rate+ISPS Rate)/100)*(Loan Tenor/360)*Amount of Invoice

where the Partner Financier Rate is a predetermined mark-up established by financial institution 28 representing, at least in part, fees charged by financial institution 28 for providing financing participation.

After IPSP 26 determines the applicable discount for an invoice, IPSP 26 stores all details of the calculation, e.g., in database 120, for future use. IPSP 26 then schedules 512 the invoice for payment. In the example embodiment, IPSP 26 is configured to pay financed invoices within a short period of time, for example within two business days after verification. Payment 512 of payee 24 is accomplished using any suitable payment method, including but not limited to, payment via check or other tangible instrument, wire transfer, and/or ACH deposit. Accordingly, in the example embodiment, payment 512 includes transmitting payment information to payee 24, wherein the payment information may include, but is not limited to, information regarding a check number and date of mailing, wire transfer information, and/or ACH deposit information.

After IPSP 26 pays 512 the financed invoices, IPSP 26 generates 514 a first approved invoice file which contains information relating to invoices financed with the participation of a third-party partner financial institution 28. As described above, historically, payee invoices that fall into certain categories (collectively referred to herein as “low-yield invoices”), including but not limited to low average invoice amount and low cumulative invoice dollar amount have not been good candidates for known financing programs between a payor 22 and a third-party partner financial institution 28. Specifically, the dollar amounts in those categories historically have not been large enough, when considered in combination with the costs involved in processing such invoices, to present a sufficient financial return to a third-party partner financial institution 28 to warrant involvement by a financial institution 28.

In the example embodiment, IPSP 26 enables such low-yield invoices to be included in invoice financing programs. Specifically, as part of the generation 514 of the first approved invoice file, IPSP 26 aggregates 516 invoices payable by payor 22 according to one or more criteria, as described in further detail hereinbelow, to create a collection of debt obligations that, as a whole, represents a dollar amount that is capable of providing a sufficiently large return to be of interest to a third-party partner financial institution 28. In one embodiment, IPSP 26 may select a predetermined minimum total amount that represents a minimum total value that IPSP 26 would present to any potential third-party partner financial institution 28 for consideration. In an alternative embodiment, IPSP 26 may adopt as an aggregation rule, different predetermined dollar amounts corresponding to different specific potential third-party partner financial institutions, wherein the different amounts are selected by IPSP 26 based on factors that may include, but are not limited to, past experience with specific third-party financial institutions 28, and information and/or rules provided by specific third-party financial institutions 28.

In the example embodiment, individual invoices of any value may be considered for aggregation with one or more other invoices. In an alternative embodiment, IPSP 26 may adopt a rule that an invoice that is above a predetermined value is deemed to be sufficiently large that aggregation with other invoices is not necessary to be of interest to a third-party partner financial institution 28. Moreover, in the example embodiment, any quantity of invoices may be aggregated together that enables method 500 to be performed as described herein.

In the example embodiment, IPSP 26 is configured to aggregate invoices by various categories, including but not limited to:
1. Rules defined by payor 22 (found in the payor profile);
2. Payee Identity;
3. Predetermined Payee/Payor pairings;
4. Significant Dates: Invoice (e.g., date of issue or receipt), Shipment, IPSP Process, Payee Due Date, Client Funds Due Date;
5. Invoice type, including but not limited to: Freight, Utility, and Telecommunications; and
6. Currency.

In the example embodiment, IPSP 26 aggregates invoices through application of at least two of the just-described categories, for example aggregating invoices by date and payee. More specifically, any combination of the just-described categories, including all, may be used that enables IPSP 26 to function as described herein.

After IPSP 26 generates the first approved invoice file, IPSP 26 transmits 518 the first approved invoice file to financial institution 28 for posting on an Internet-accessible online platform maintained by financial institution 28. As part of program set-up process 400, payor 22, IPSP 26, and financial institution 28 exchange any information, including but not limited to passwords, account numbers, or any other information needed to enable payor 22 and/or IPSP 26 to access the online platform maintained by financial institution 28. In the example embodiment, depending upon the terms of the underlying contractual agreement between payor 22, IPSP 26, and financial institution 28, review and approval 520 of the first approved invoice file by payor 22 and/or financial institution 28 may be required. After receipt of payor 22 and/or financial institution 28 approval 520 of the first approved invoice file, IPSP 26 may elect to sell an entire collection of aggregated debt obligations outright to financial institution 28, and receive a discounted payment from financial institution 28.

As described above, IPSP 26 uses information regarding aggregated non-financed invoices, together with information regarding all financed invoices to generate 524 a second approved invoice file. IPSP 26 transmits the second approved invoice file to payor 22 for review. After receipt 528 by IPSP 26 of approval of the second approved invoice file from payor 22, IPSP 26 receives 530 funds from payor 22 representing payment for non-financed invoices from payee 24, and payment for funding provided by IPSP 26 for that portion of financing provided by IPSP 26. In the example embodiment, payor 22, at or about the time of payment to IPSP 26, also pays 532 to partner financial institution 28 the full amount of the open payment obligation. Finally, IPSP 26 pays 534 payee 24 for non-financed invoices on or before the due date specified in the invoices.

In the example embodiment, IPSP 26 is configured to manage multiple third-party partner financial institutions 28 simultaneously. A single financial institution 28 may be partnered with multiple payors 22 simultaneously. Accordingly, IPSP 26 is configured to report financing obligation information, sorted according to identity of payor 22, to each partner financial institution 28 on a daily basis. In the example embodiment, partner financial institutions 28, after receipt of the financing obligation information, then communicate back to IPSP 26, acknowledging receipt of the financing obligation information. Financial institutions 28 will also communicate to IPSP 26 remittance information related to the obligations reimbursed to IPSP 26.

The method steps described herein are just examples. There may be many variations to the steps (or operations) described therein without departing from the spirit of the invention. For instance, except as specifically described, the steps may be performed in a differing order, or steps may be added, deleted or modified. All of these variations are considered a part of the claimed invention.

The systems and methods are not limited to the specific embodiments described herein. In addition, components of each system and each method can be practiced independent and separate from other components and methods described herein. Each component and method also can be used in combination with other components and processes.

The methods and systems described herein facilitate efficient and economical financing of invoices from payees for the sale of goods and/or services to payors. Example embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

When introducing elements/components/etc. of the methods and systems described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for providing financing of payee invoices, the method implemented using a computer device coupled to a memory device, the method comprising:
receiving, by the computer device, at least one invoice from at least one payee, wherein the at least one invoice represents a verified debt obligation payable by a payor to the at least one payee on a specified due date;
determining, by the computer device, if the at least one verified invoice is eligible for financing to enable payment of the at least one invoice by an agreed date that is prior to the specified due date;
determining, by the computer device, whether financing of the at least one verified invoice will include participation by at least one partner;
aggregating, by the computer device, a plurality of financing-eligible invoices, including the at least one verified invoice, according to at least one aggregation criterion, to enable financing of the aggregated invoices as a unit; and
if the financing of the unit of aggregated invoices includes participation by at least one partner, receiving financing approval information from the at least one partner.

2. The method in accordance with claim 1, wherein said method comprises determining, by the computer device, whether the financing of the unit of aggregated invoices will include participation by at least one partner.

3. The method in accordance with claim 2, wherein determining whether the financing of the unit of aggregated invoices comprises determining, by the computer device, whether at least one of the aggregated invoices is in an amount greater than a predetermined amount, wherein if at least one invoice is greater than the predetermined amount, financing of the unit of aggregated invoices will include participation by at least one partner.

4. The method in accordance with claim 1, wherein aggregating a plurality of financing-eligible invoices according to at least one aggregation criterion comprises aggregating the plurality of financing-eligible invoices according to at least one of a set of client-defined rules, a payee identity, a set of predetermined payee-payor pairings, a set of predetermined dates, an invoice type, and a currency.

5. The method in accordance with claim 1, wherein the at least one invoice relates to at least one shipment on behalf of a payor.

6. The method in accordance with claim 1, said method comprising determining, by the computer device, an amount of a discount to be paid by the payee, if the at least one verified invoice is determined to be eligible for financing.

7. The method in accordance with claim 6, wherein the amount of the discount is one of a predetermined fixed discount amount and a variable discount amount wherein the variable discount amount is determined using the formula:
Variable Discount Amount=((LIBOR Rate+Partner Financier Rate+IPSP Rate)/100)*(Loan Tenor/360)*Amount of Invoice,
and wherein
LIBOR=((((TN−T1)*(R2−R1))/(T2−T1))+R1),
Where
R1=A Rate of a first known LIBOR Index Rate,
R2=A Rate of a second known LIBOR Index Rate,
T1=A Term associated with R1,
T2=A Term associated with R2, and
Tn=A Loan Period for a Financed Invoice,
and wherein
Partner Financier Rate=a predetermined rate applied by a partner if a partner is participating in financing, and
IPSP Rate=a predetermined rate applied by an invoice payment service provider associated with the computer device.

8. The method in accordance with claim 1, said method comprising:
designating as a financing program, financing for a pairing of a payee with a payor;
assigning a financing program identifier to the financing program; and
designating a payee for participation in a plurality of financing programs that include a plurality of payors.

9. The method in accordance with claim 1, said method comprising:
transferring the verified debt obligation represented by the at least one verified invoice outright to a third party financial institution; and
receiving as payment in exchange for the transferred verified debt obligation a predetermined discount amount.

10. A computer system for providing financing of payee invoices, said system comprising:
a processor; and
a computer-readable storage device having encoded thereon computer-readable instructions that are executable by the processor to perform functions comprising:
receiving at least one invoice from at least one payee, wherein the at least one invoice represents a verified debt obligation payable by a payor to the at least one payee on a specified due date;
determining if the at least one verified invoice is eligible for financing to enable payment of the at least one invoice by an agreed date that is prior to the specified due date;
determining whether financing of the at least one verified invoice will include participation by at least one partner;
aggregating a plurality of financing-eligible invoices, including the at least one verified invoice, according to at least one aggregation criterion, to enable financing of the aggregated invoices as a unit; and
if the financing of the unit of aggregated invoices includes participation by at least one partner, receiving financing approval information from the at least one partner.

11. The computer system in accordance with claim 10, wherein the computer-executable instructions cause the processor to determine whether the financing of the unit of aggregated invoices will include participation by at least one partner.

12. The computer system in accordance with claim 11, wherein the computer-executable instructions cause the processor to determine whether at least one of the aggregated invoices is in an amount greater than a predetermined amount, wherein if at least one invoice is greater than the predetermined amount, financing of the unit of aggregated invoices will include participation by at least one partner.

13. The computer system in accordance with claim 10, wherein the at least one invoice relates to at least one shipment on behalf of a payor.

14. The computer system in accordance with claim 10, wherein the computer-executable instructions cause the processor to determine an amount of a discount to be paid by the payee, if the at least one verified invoice is determined to be eligible for financing.

15. The computer system in accordance with claim 14, wherein the amount of the discount is one of a predetermined fixed discount amount and a variable discount amount wherein the variable discount amount is determined using the formula:
Variable Discount Amount=((LIBOR Rate+Partner Financier Rate+IPSP Rate)/100)*(Loan Tenor/360)*Amount of Invoice,
and wherein
LIBOR=((((TN−T1)*(R2−R1))/(T2−T1))+R1),
Where
R1=A Rate of a first known LIBOR Index Rate,
R2=A Rate of a second known LIBOR Index Rate,
T1=A Term associated with R1,
T2=A Term associated with R2, and
Tn=A Loan Period for a Financed Invoice,
and wherein
Partner Financier Rate=a predetermined rate applied by a partner if a partner is participating in financing, and
IPSP Rate=a predetermined rate applied by an invoice payment service provider associated with the computer system.

16. The computer system in accordance with claim 10, wherein the computer-executable instructions cause the processor to verify a correctness of the at least one verified invoice through application of at least one business rule.

17. The computer system in accordance with claim 10, wherein the computer-executable instructions cause the processor to aggregate the plurality of financing-eligible invoices according to at least one of a set of client-defined rules, a payee identity, a set of predetermined payee-payor pairings, a set of predetermined dates, an invoice type, and a currency.

18. The computer system in accordance with claim 10, wherein the computer-executable instructions cause the processor to:
designate as a financing program, financing for a pairing of a payee with a payor;
assign a financing program identifier to the financing program; and
designate a payee for participation in a plurality of financing programs that include a plurality of payors.

19. The computer system in accordance with claim 10, wherein the computer-executable instructions cause the processor to:
transfer the verified debt obligation represented by the at least one verified invoice outright to a third party financial institution; and
receive as payment in exchange for the transferred verified debt obligation a predetermined discount amount.

20. Computer-readable storage media having computer-executable instructions thereon, wherein when executed by at least one processor associated with a host computer device and a memory device, the computer-executable instructions cause the at least one processor to:
receive at least one invoice from at least one payee, wherein the at least one invoice represents a verified debt obligation payable by a payor to the at least one payee on a specified due date;
determine if the at least one verified invoice is eligible for financing to enable payment of the at least one invoice by an agreed date that is prior to the specified due date;
determine whether financing of the at least one verified invoice will include participation by at least one partner;
aggregate a plurality of financing-eligible invoices, including the at least one verified invoice, according to at least one aggregation criterion, to enable financing of the aggregated invoices as a unit; and
if the financing of the unit of aggregated invoices includes participation by at least one partner, receive financing approval information from the at least one partner.

21. The computer-readable storage media in accordance with claim 20, wherein the computer-executable instructions cause the processor to aggregate the plurality of financing-eligible invoices according to at least one of a set of client-defined rules, a payee identity, a set of predetermined payee-payor pairings, a set of predetermined dates, an invoice type, and a currency.

22. The computer-readable storage media in accordance with claim 20, wherein the computer-executable instructions cause the processor to determine whether the financing of the unit of aggregated invoices will include participation by at least one partner.

23. The computer-readable storage media in accordance with claim 22, wherein the computer-executable instructions cause the processor to determine whether at least one of the aggregated invoices is in an amount greater than a predetermined amount, wherein if at least one invoice is greater than the predetermined amount, financing of the unit of aggregated invoices will include participation by at least one partner.

24. The computer-readable storage media in accordance with claim 20, wherein the at least one invoice relates to at least one shipment on behalf of a payor.

25. The computer-readable storage media in accordance with claim 20, wherein the computer-executable instructions cause the processor to determine an amount of a discount to be paid by the payee, if the at least one verified invoice is determined to be eligible for financing.
